(19) United States
(12) Patent Application Publication
(10) Pub. No.: US 2013/0262445 A1
(43) Pub. Date: Oct. 3, 2013

(54) BROWSING REAL-TIME SEARCH RESULTS RELIABLY ON A MOBILE COMPUTING DEVICE

(71) Applicants: Francisco Corella, San Diego, CA (US); Karen Pomian Lewison, San Diego, CA (US)

(72) Inventors: Francisco Corella, San Diego, CA (US); Karen Pomian Lewison, San Diego, CA (US)

(73) Assignee: Pomian & Corella, LLC, San Diego, CA (US)

(21) Appl. No.: 13/479,248

(22) Filed: May 23, 2012

Related U.S. Application Data
(63) Continuation-in-part of application No. 13/437,927, filed on Apr. 2, 2012, now Pat. No. 8,452,749.

(51) Int. Cl. G06F 17/30; G06F 3/01

(52) U.S. Cl. 707/722; 707/E17.014

(57) ABSTRACT

A system for browsing real-time search results reliably on mobile computer device. In one embodiment, the system comprises a search application that runs on a mobile computing device equipped with a touch screen display, and obtains search results from a search back-end connected to the device through the Internet. A user submits a query and the search application renders results pertaining to a snapshot of a result set of the query in a scrollable visual container shown on the display. The user requests an increase in the number of results listed in the container by attempting to scroll the container beyond a maximally scrolled position, using a swipe gesture. The search application replaces the list of results shown in the container with a longer list of results pertaining to a more recent snapshot of the result set, highlighting those results that have not been previously shown to the user.

### CROSS-REFERENCE TO RELATED APPLICATION

This application is a continuation-in-part of application Ser. No. 13/437,927, filed on Apr. 2, 2012.

### BACKGROUND

Today most search engines include results pertaining to data sources that change frequently, and strive to reflect data source changes in result sets of queries soon after the changes occur. Results produced by such search engines are referred to as “real-time results”.

A result set that comprises real-time results is likely to change while it is being browsed by a user. Some search engines order results within a result set according to a rank assigned to each result. (A result with higher rank has a lower result number in the result set; result No. 1 is the lowest-numbered and highest-ranking result in the result set.)

Some search engines base the ranking of results on both recency and relevance, relevance referring to hypothesized importance to the user. A result set produced by such a search engine in response to a query may change unpredictably, as new results appear and the ranking of existing results changes. For example, the rank of a tweet that matches a query may go down after the query was issued as more recent results appear, but may also go up if a cascade of retweets causes an increase in relevance that outweighs the decrease in recency.

Traditional search engines provide a paginated user interface for browsing a result set, with a page menu for navigation. Some more modern search engines, on the other hand, provide endless scrolling as an alternative to the traditional page menu for navigation.

With endless scrolling, results are shown in a list of unlimited length rather than in a collection of pages of fixed length. To view higher-numbered results the user causes additional results to be appended to the list by attempting to scroll beyond the end of the list. To go back to lower-numbered results, the user simply scrolls up towards the beginning of the list.

Endless scrolling is more convenient than a page menu for mobile devices: a mobile device has a touchscreen display, which makes it easy to scroll with a swipe gesture; while on a small mobile device such as a smart phone it is difficult to tap on the small buttons of a page menu.

However, when endless scrolling is used to browse real-time search results, results may be lost. For example, a search application running on a mobile device may obtain from a search back-end results Nos. 1-10 of a result set of a query, and display them to the user. The user may then attempt to scroll beyond the tenth result in order to see more results. The search application may then retrieve results Nos. 11-20 and append them to the list of displayed results. However, the result set may have changed between the time when results Nos. 1-10 were retrieved and the time when results Nos. 11-20 are retrieved. If the result that was result No. 11 when results Nos. 1-10 were retrieved is, e.g., result No. 3 by the time results Nos. 11-20 are retrieved, that result will not be included among the 20 displayed results. That result will thus be lost to the user.

It is therefore desirable to provide a method of browsing real-time search results that uses scrolling for navigation instead of a page menu, and yet does not lose results. Such a method is particularly desirable for mobile devices that use a swipe gesture for scrolling.

### SUMMARY

In one embodiment, a system is provided for browsing real-time search results reliably without using a page menu, which is an alternative to a system for browsing real-time search results effectively with a paginated user interface, provided by application Ser. No. 13/437,927.

The system comprises a search application that runs on a mobile computing device equipped with a touch screen display, and obtains search results from a search back-end connected to the device through the Internet.

A user submits a query and the search application renders results pertaining to a snapshot of a result set of the query in a scrollable visual container shown on the display. The user requests an increase in the number of results listed in the container by attempting to scroll the container beyond a maximally scrolled position, using a swipe gesture. The search application replaces the list of results shown in the container with a longer list of results pertaining to a more recent snapshot of the result set, highlighting those results that have not been previously shown to the user.

If there are highlighted results above the visible portion of the container, the search application scrolls the container so that the lowest-numbered highlighted result is fully visible.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. Reference numerals consist of a concatenation of a one- or two-digit number referring to a figure, followed by a two-digit number that locates the referenced part within the figure. A reference numeral introduced in a figure may be used in other figures to refer to the same part or a similar part.

FIG. 1 is a block diagram generally illustrating a system for browsing real time search results reliably, according to embodiments.

FIG. 2 is a block diagram illustrating a user-interface subsystem of a traditional personal computer, according to one embodiment.

FIG. 3 is a block diagram illustrating a user-interface subsystem of a mobile computing device, according to one embodiment.

FIG. 4 is a block diagram illustrating a search application embedded in a web page, according to one embodiment.

FIG. 5 is a block diagram illustrating a search application that is a native application running on a mobile computing device, according to one embodiment.

FIG. 6 is a block diagram illustrating an example of a result in an embodiment where all results describe tweets.

FIG. 7 illustrates a JSON encoding of a result, according to one embodiment.

FIG. 8 shows an example of a tweet URL.

FIG. 9 illustrates a rendering of a tweet result, according to one embodiment.

FIG. 10 is a block diagram illustrating an example of a tweet result in a heterogeneous embodiment where queries produce results of several kinds.

FIG. 11 is a block diagram illustrating an example of a result that describes a Web page in a heterogeneous embodiment.

FIG. 12 illustrates a rendering of a result that describes a Web page, according to one embodiment.

FIG. 13 illustrates an example of user-interface elements shown on a touch-screen display after the user has submitted a query, according to one embodiment.

FIG. 14 illustrates an example of user-interface elements shown on a touch-screen display according to an embodiment where the visual portion of a scrollable visual container occupies the entire area of a display.

FIG. 15 illustrates a user requesting an increase in the number of results shown in a scrollable visual container using a swipe gesture on a touch-screen display, according to one embodiment.

FIG. 16 illustrates a scrollable visual container where a lowest-numbered highlighted result is visible, according to one embodiment.

FIG. 17 is a block diagram illustrating an example of browsing data used by a search application, according to one embodiment.

FIG. 18 is a flow diagram illustrating a process followed by a search application to render an initial list of results of a query, according to one embodiment.

FIG. 19 is a flow diagram illustrating a process followed by a search application upon a user requesting an increase in the number of results shown in a scrollable visual container, according to one embodiment.

FIG. 20 is a flow diagram illustrating a process followed by a search application in response to a user requesting a refresh of the results in a scrollable visual container, according to one embodiment.

FIG. 21 is a flow diagram illustrating a process followed by a search application to request results from a back-end and render them in a scrollable visual container, according to one embodiment.

FIG. 22 is a flow diagram illustrating a process followed by a search application to render a list of results, according to one embodiment.

FIG. 23 is a flow diagram illustrating a process followed by a search application to render a result, highlighting it if not previously shown, according to one embodiment.

FIG. 24 is a flow diagram illustrating a process followed by a search application to resume the browsing of real-time search results in container 1410 after exiting and restarting, according to one embodiment.

### DETAILED DESCRIPTION

This Detailed Description refers to the accompanying drawings, which are a part hereof and illustrate examples of embodiments of the invention. It is to be understood that other embodiments are possible, and that the features of different exemplary embodiments can be combined together unless otherwise stated. It is to be understood that method steps mentioned in the claims may be performed in any feasible order, and any feasible combination of two or more steps may be performed simultaneously.

Hereinafter, the word “Web”, when capitalized, refers to the World-Wide Web, while the word “web”, not capitalized, is a broader reference to the Hypertext Transfer Protocol (HTTP) that is used in the Web. The term “web client computer” refers to a computer capable of sending HTTP requests and receiving HTTP responses. The term “web server computer” refers to a computer capable of receiving HTTP requests and sending HTTP responses.

Hereinafter, the term web application programming interface (web API) refers to an interface exposed by a web server computer that lets a web client computer send HTTP requests to the web server computer and obtain HTTP responses containing web pages or data encoded in a language suitable for data structure transmission, such as XML or JSON. HTTP requests and responses may be sent over transport-layer connections such as TCP connections or secure TLS connections.

Hereinafter, the term “web page” refers to a file written in a version of Hyptertext Markup Language (HTML), such as HTML5, which may include JavaScript code and may incorporate by reference other files such as HTML files, media files, JavaScript files, .XAP files pertaining to the Microsoft Silverlight application framework, and .SWF files pertaining to the Adobe Flash and Adobe Flex application frameworks.

Hereinafter, the term “web browser”, or simply “browser”, refers to an application running on a web client computer, capable of visiting web pages.

Hereinafter, the term “uniform resource locator”, or “URL”, refers to an address of a web resource, such as a file containing a text document, or a file containing a media document such as a file or a video or a sound recording, or a web page, or a fragment of a web page; an example of a fragment of a web page is a comment on a blog post. The URL is said to reference, or point to, the web resource.

Hereinafter, the term “hyperlink” refers to a text string or other visual element that has an associated, or underlying, URL. The text or other visual element is called the “label” of the URL. The hyperlink uses the underlying URL to reference, or point to, a web resource, and can be actuated (e.g. clicked with a mouse or tapped with a finger if shown on a touch-screen display) to retrieve the resource referenced by the URL. When the hyperlink is displayed by a browser or by a web application running within a browser, and the URL refers to a web page or a fragment, actuating the hyperlink may cause the browser to visit the page or fragment. When the hyperlink is displayed by a native application and the URL refers to a web page or a fragment, actuating the hyperlink may cause the native application to pass the URL to a browser that will visit the page or fragment, the browser being launched to that purpose if it is not already running; the browser may be embedded in the native application or external to the native application.

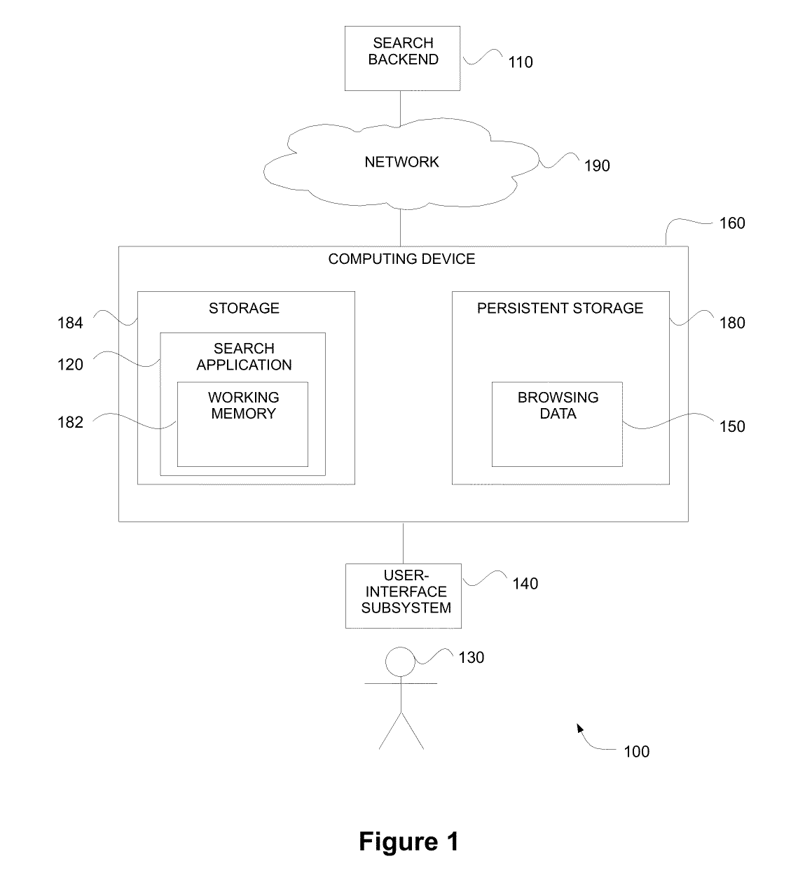

FIG. 1 is a block diagram generally illustrating a system 100 for browsing real time search results reliably on a computing device 160, according to embodiments described herein, including, but not limited to, embodiments where the computing device is a mobile computing device. System 100 includes a search application 120 running on the computing device, and a search back-end 110 connected to the computing device through a network 190 such as the Internet or an intranet. In one embodiment, the search application accesses the back-end via a web API exposed by the back-end. In one embodiment the back-end is a server farm comprising a search index, as described in patent application Ser. No. 13/437,927.

Search application 120 is stored in a computer readable storage medium (henceforth, a “storage”) 184 that is part of computing device 160, and contains instructions for controlling the computing device to perform a method of browsing a time-varying result set of a search query submitted by a user 130 (henceforth, “the user”), with whom it communicates via a user-interface subsystem 140 connected to computing device 160.

Back-end 110 defines a time-varying result set of the query, which can be viewed as a time-series of result set snapshots, each snapshot being an ordered sequence of results.

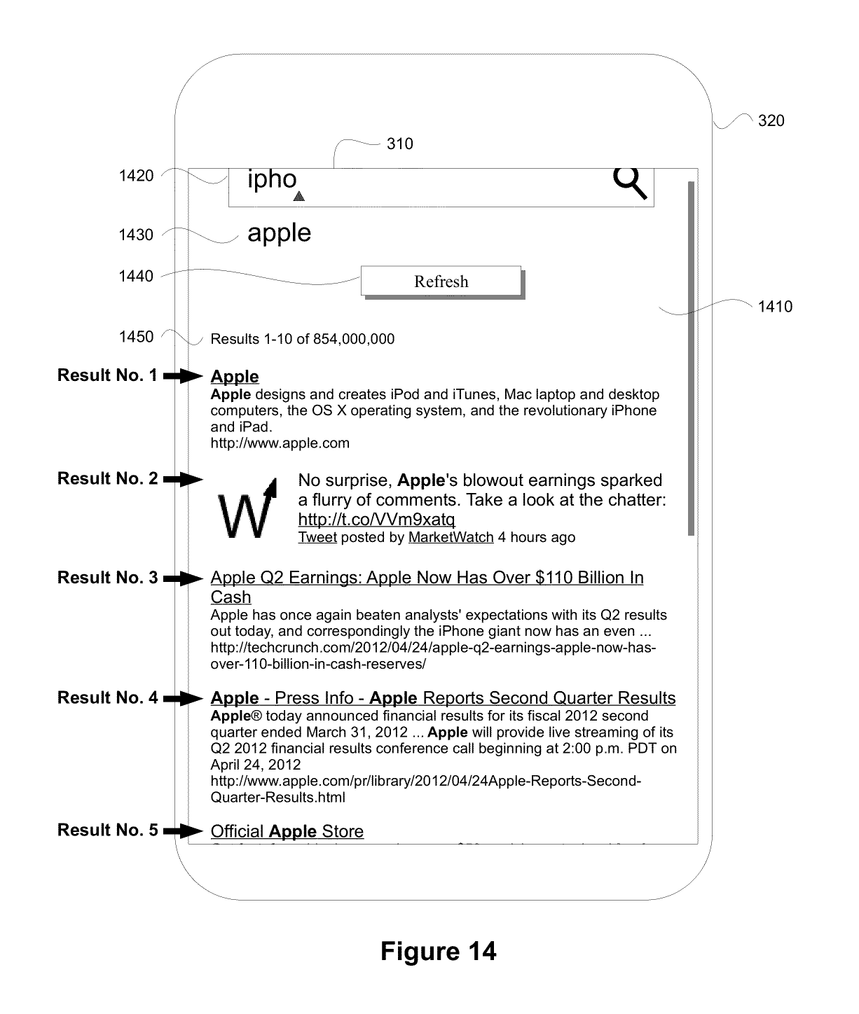

Search application 120 obtains lists of consecutive results from back-end 110. Lists of results obtained at different times pertain to different snapshots. For example, the search application may obtain results Nos. 1-10 of a first snapshot, and, later, results Nos. 1-20 of a second snapshot; the same result may occupy different positions in the two snapshots, e.g. it may be result No. 11 in the first snapshot and result No. 3 in the second snapshot, as illustrated below in FIGS. 14, 15 and 16.

Search application 120 allows the user to resume browsing the result set after the application exits and restarts, even if the computing device has been powered off in the meantime. To do so, the search application preserves browsing data 150 needed for resumption after a restart in a persistent storage 180 whose contents are preserved while the application is not running, while other data is stored in a working memory 182, whose contents are lost when the search application exits. In one embodiment, browsing data 150 is stored in working memory 182 while the search application is running, saved to persistent storage 180 when the application exits, and restored from persistent storage 180 to working memory 182 when the application resumes. In an alternative embodiment, browsing data 150 is always stored in persistent storage 180, the application being able to read and write browsing data 150 in the persistent storage.

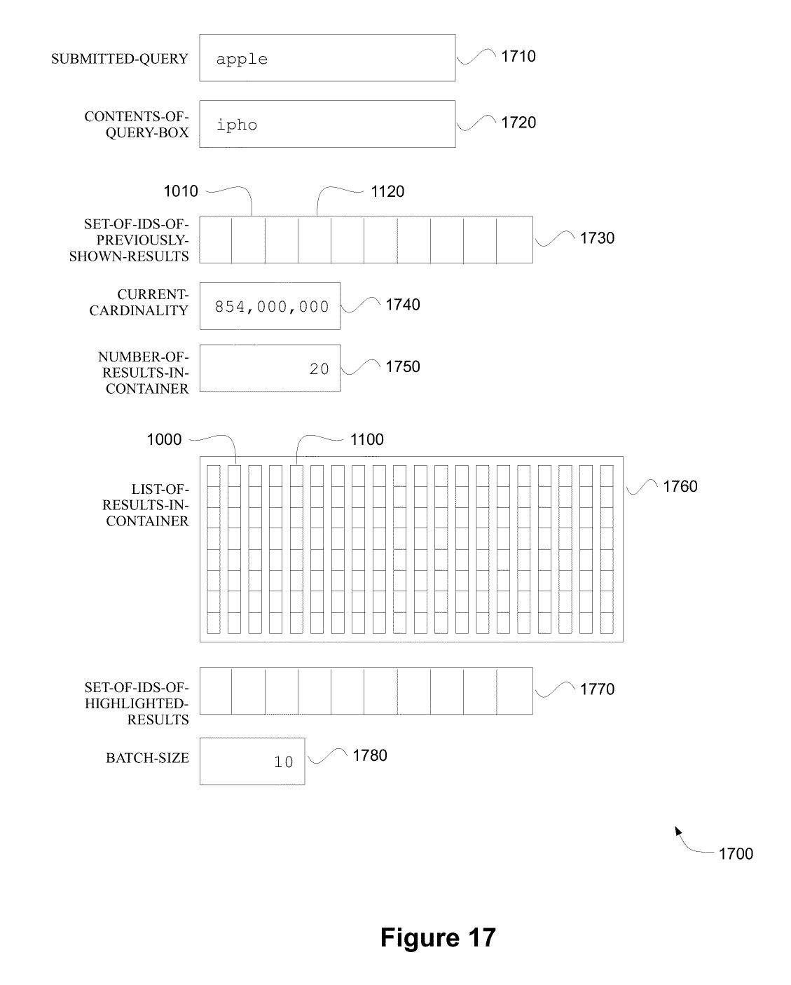

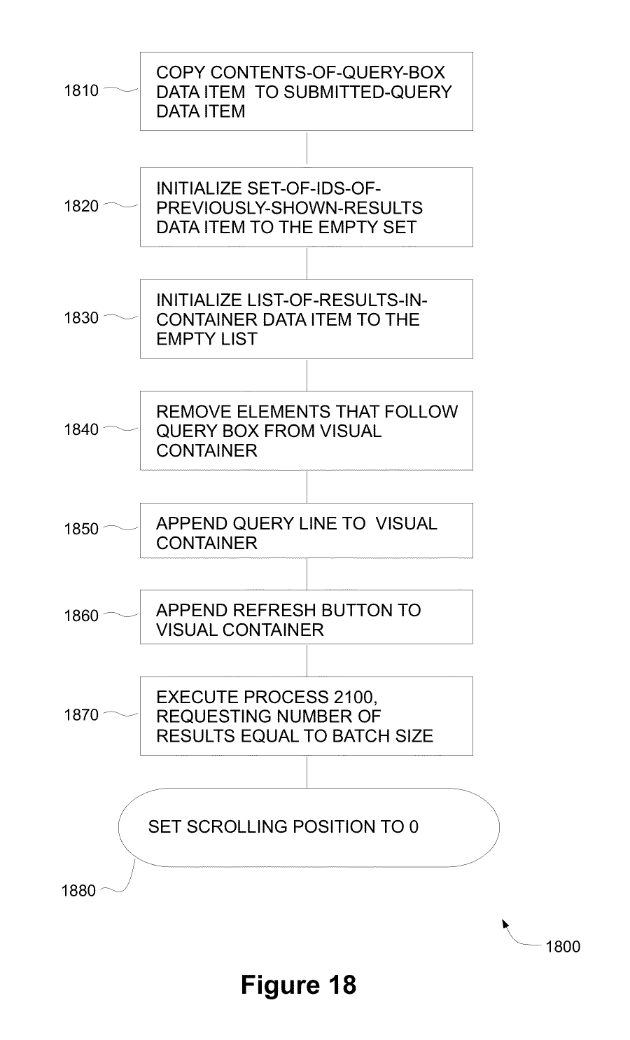

Data items of browsing data 150 are shown in FIG. 17 and discussed in connection with FIG. 17.

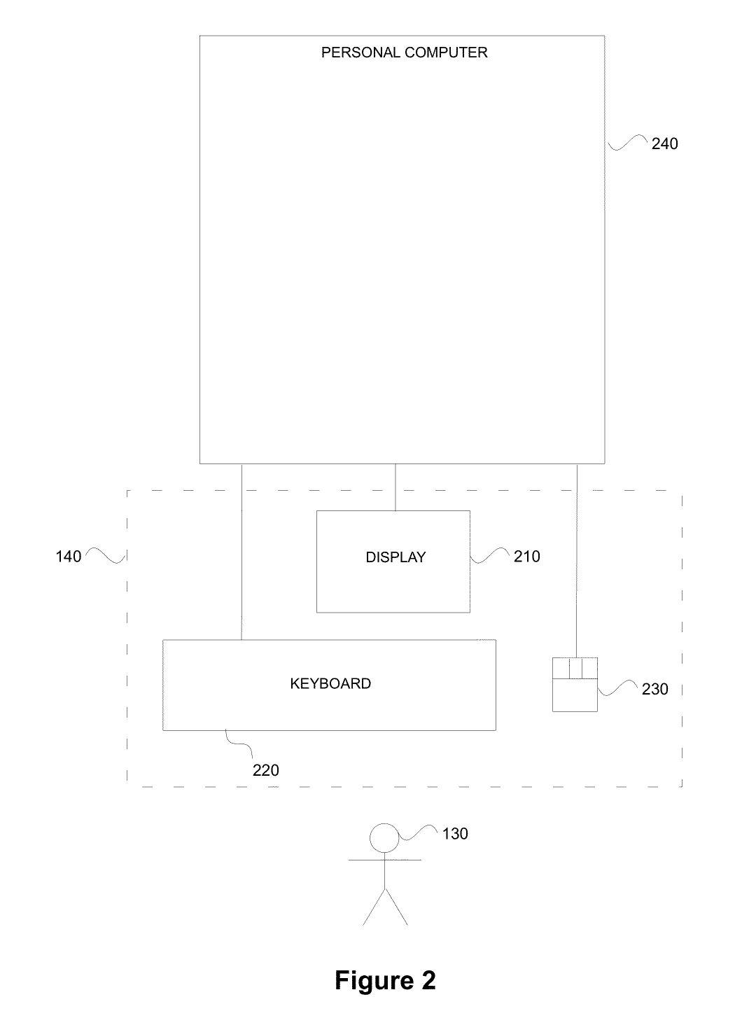

FIG. 2 is a block diagram illustrating user-interface subsystem 140, according to one embodiment that features a traditional personal computer 240, such as a desktop, laptop or notebook computer, in the role of the computing device 160 of FIG. 1. In the embodiment, user-interface subsystem 140 comprises a display 210, a keyboard 220 and a pointing device 230 such as a mouse, trackball or trackpad, all connected to personal computer 240.

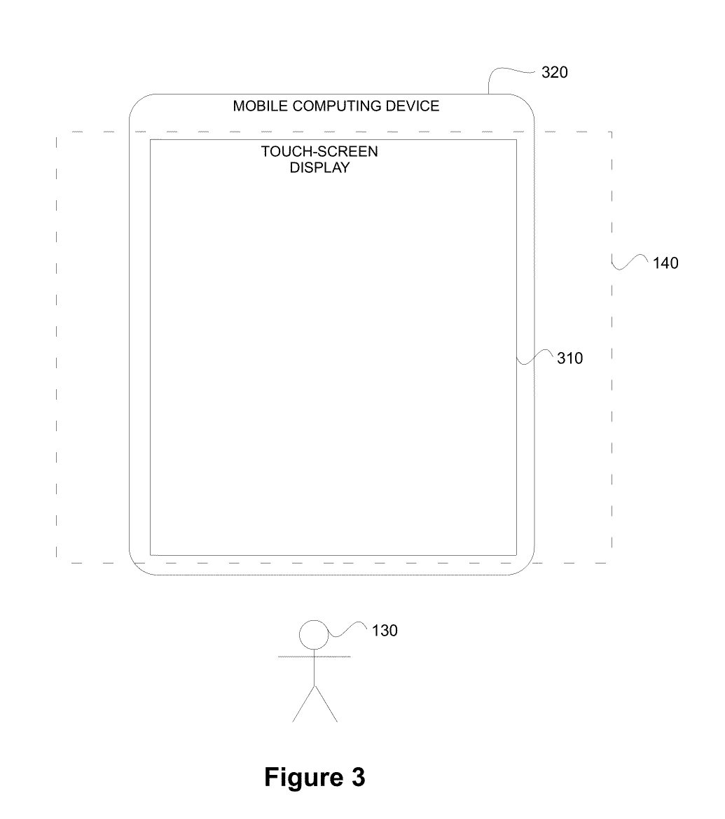

FIG. 3 is a block diagram illustrating user-interface subsystem 140, according to one embodiment that features a mobile computing device 320, such as a smart phone or a tablet, in the role of the computing device 160 of FIG. 1. In the embodiment, user-interface subsystem 140 has only one component, a touch-screen display 310 embedded in the device. The connection between computing device 160 and user-interface subsystem 140 shown by a line in FIG. 1 is realized in FIG. 3 by touch-screen display 310 being embedded in mobile computing device 320.

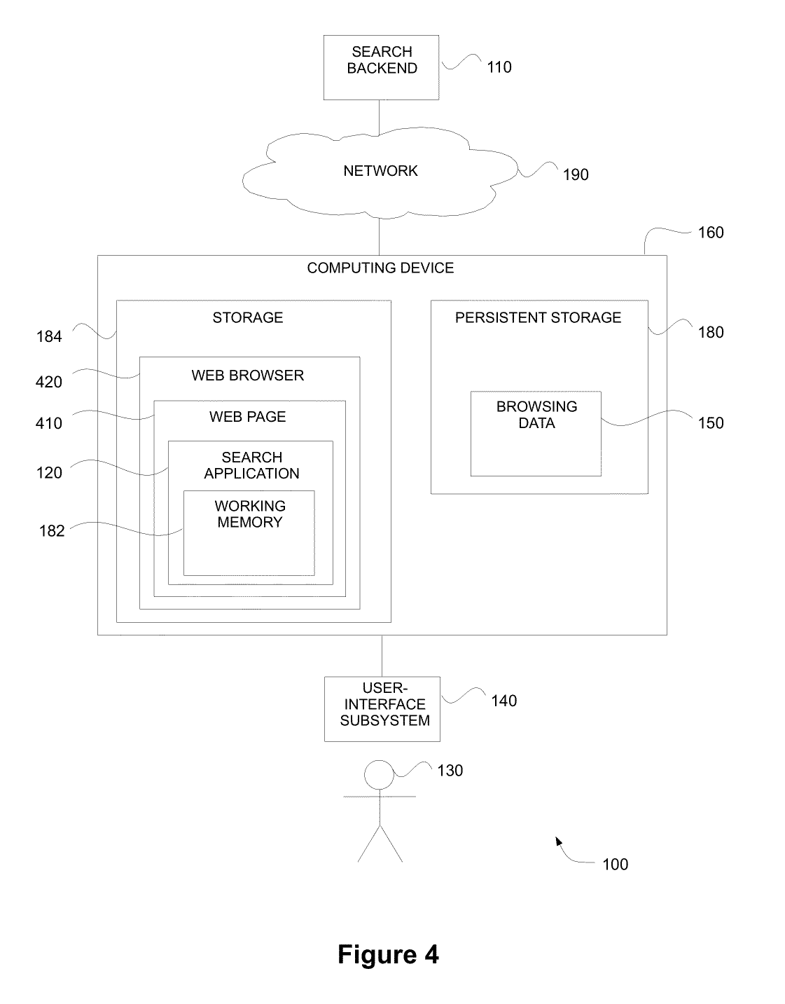

FIG. 4 is a block diagram illustrating system 100, according to one embodiment where search application 120 is embedded in a web page 410 that has been downloaded into a browser 420 running on computing device 160 and stored in storage 184. In one embodiment, the search application is a JavaScript web application of a kind described in patent application Ser. No. 13/437,927. In alternative embodiments the search application is a Flex web application, a Silverlight web application, or a web application residing in a browser extension; such kinds of web applications are also described in patent application Ser. No. 13/437,927.

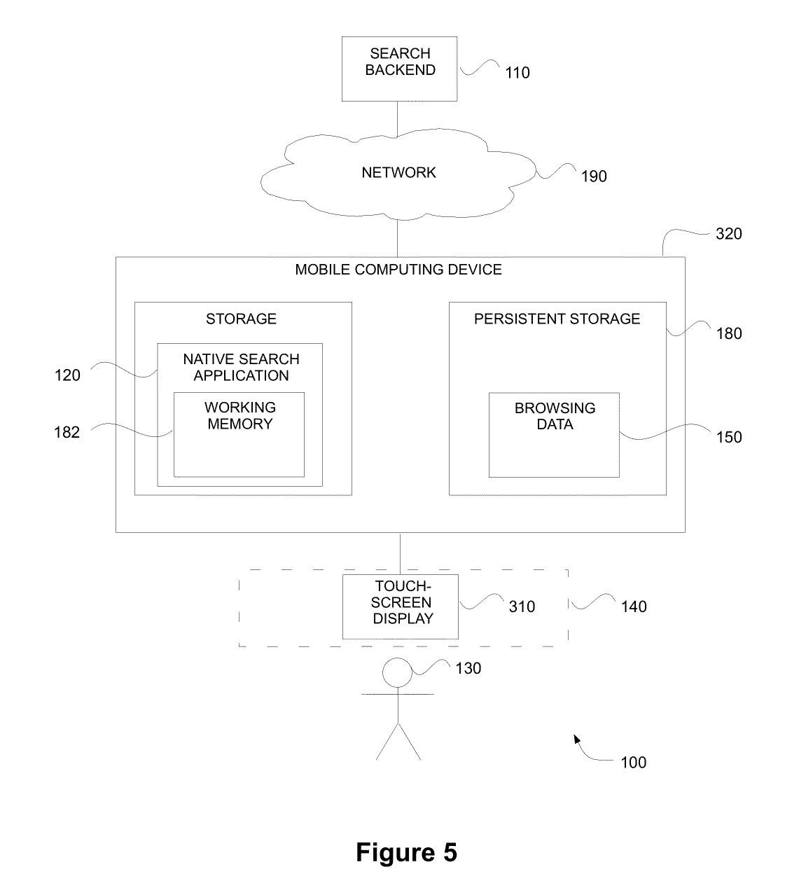

FIG. 5 is a block diagram illustrating system 100, according to embodiments where search application 120 is a native application running on a mobile computing device 320 that plays the role of the computing device 160 of FIG. 1, and user-interface subsystem 140 consists of a touch-screen display 310. In one embodiment persistent storage 180 is a file system; browsing data 150 is stored in the working memory 182 while the search application is running, saved to the file system when the application exits, and restored from the file system to the working memory when the application resumes. In an alternative embodiment, mobile computing device 320 is an iOS device such as an iPhone or an iPad and persistent storage 180 is an iOS Core Data Persistent Object; browsing data 150 is always stored in the Persistent Object, the application being able to read and write browsing data 150 in the Persistent Object.

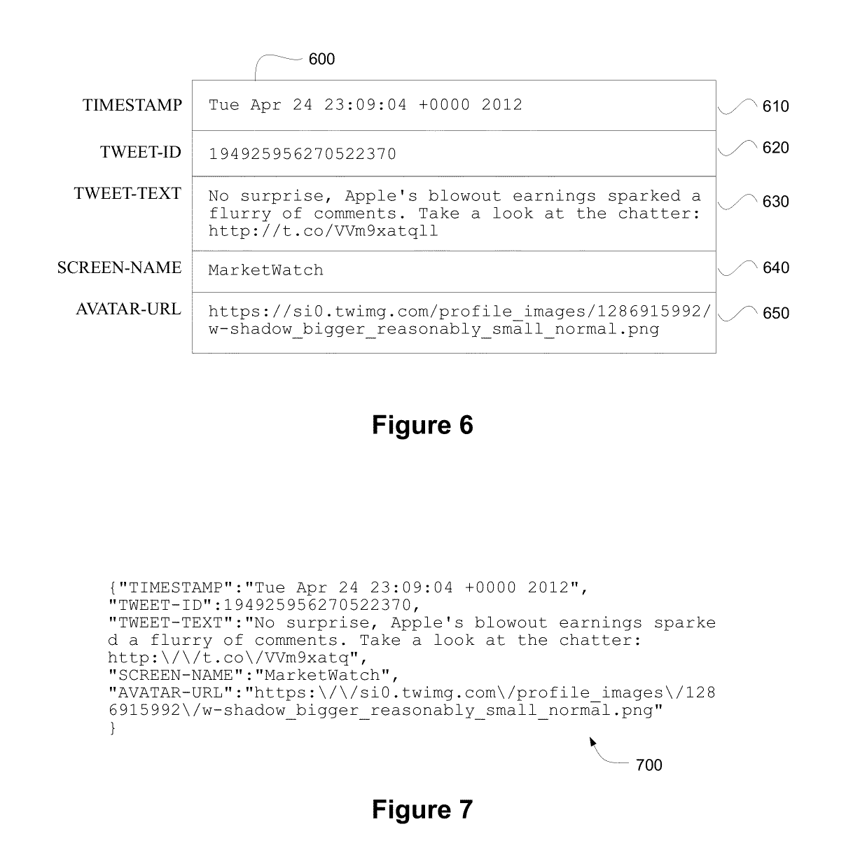

FIG. 6 is a block diagram illustrating an example of a result 600, according to one embodiment where all results describe tweets. The result belongs to a snapshot of a result set of a query that consists of the string “apple”. The result is a record including a TIMESTAMP data item 610, a TWEET-ID data item 620 comprising a tweet identifier assigned by Twitter to the tweet, a TWEET-TEXT data item 630 comprising the text of the tweet, a SCREEN-NAME data item 640 comprising a screen name associated with a Twitter account from which the tweet was posted, and an AVATAR-URL data item 650 comprising a URL that points to an avatar associated with the Twitter account. Since all results are tweets, the TWEET-ID data item 620 is guaranteed to be unique and can serve as result identifier for result 600.

In one embodiment back-end 110 encodes result 600 in a language suitable for describing data structures, such as XML or JSON, before sending result 600 to search application 120 as part of the snapshot of the result set of the example of FIG. 6.

FIG. 7 illustrates a JSON encoding 700 of result 600, according to one embodiment. (The lines beginning with “tweet-id” and “avatar-url” have been wrapped around to fit in the page.)

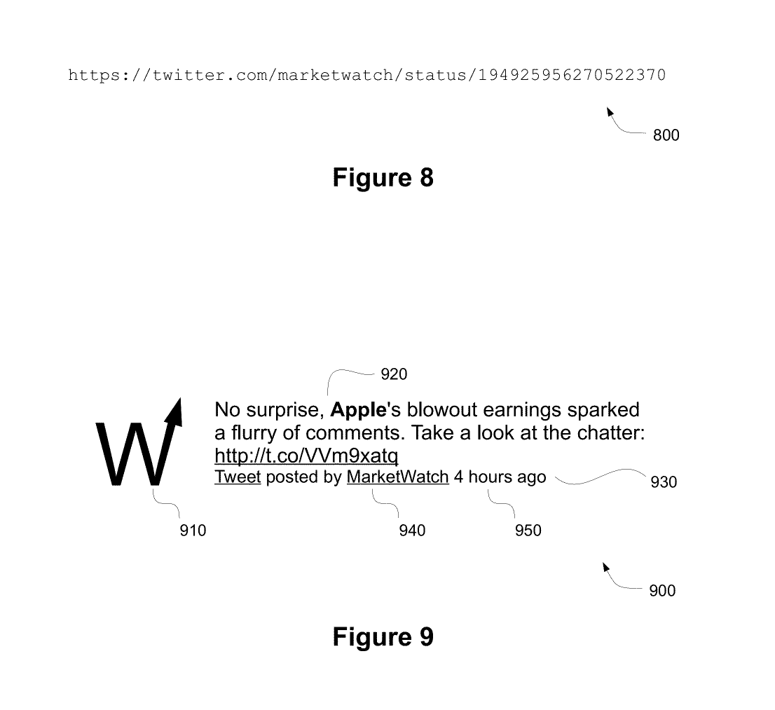

FIG. 8 shows an example of a tweet URL 800, which points to a Web page that displays the tweet described by result 600 of FIG. 6. (The page belongs to the Twitter Web site.) In one embodiment, search application 120 is programmed to derive the tweet URL 800 from the TWEET-ID data item 620 and the SCREEN-NAME data item 640 of result 600.

In one embodiment, a result is shown on a display by formatting and displaying information contained in or referenced by the result. The process of formatting such information in order to show the result is referred to as “rendering the result”, and an outcome of such formatting is referred to as “a rendering” of the result. “Rendering a list of results” in a visual container shown on a display means concatenating the renderings of the results included in the list and placing the concatenation in the visual container.

FIG. 9 illustrates a rendering 900 of result 600 on a display, according to one embodiment. The rendering comprises an avatar 910, the text of the tweet 920, and a line 930 including the screen name 940 of the Twitter account from which the tweet was posted and an indication 950 of how long ago the tweet was posted, derived by search application 120 from TIMESTAMP data item 610. The avatar is obtained by search application 120 using AVATAR-URL data item 650. The text of the tweet is the value of TWEET-TEXT data item 630. The search application renders the URL “http://t.co/VVm9xatq” within the tweet text as a hyperlink, the URL being both the label of the hyperlink and the underlying URL. Within line 930, the word “Tweet” is rendered as a hyperlink whose underlying URL is the tweet URL 800, and the screen name 940 as a hyperlink with underlying URL “https://twitter.com/#!/MarketWatch”, which points to the Twitter page of the Twitter account from which the tweet was posted. In one embodiment different colors are used to distinguish different elements of the rendering.

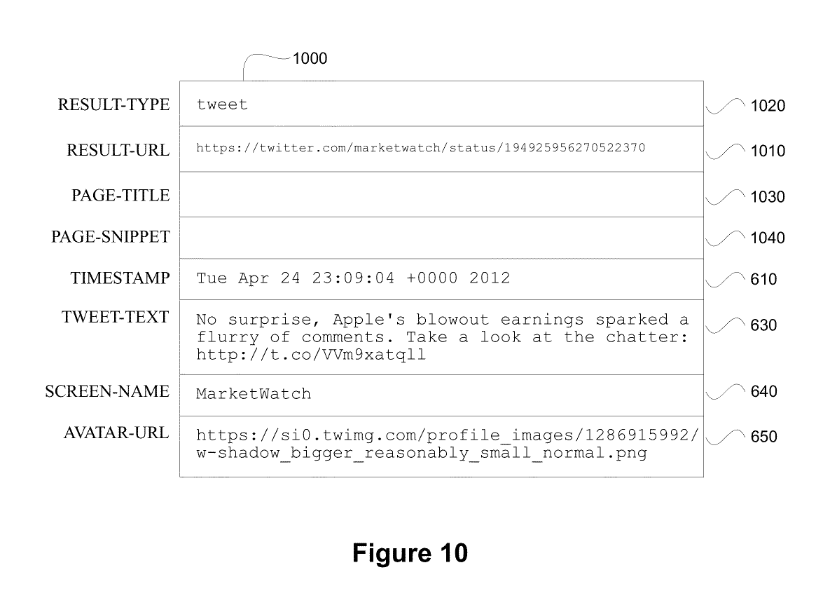

FIG. 10 is a block diagram illustrating an example of a result 1000, according to a heterogeneous embodiment where queries produce results of several different kinds Result 1000 is a record describing the same tweet as result 600.

Like result 600, result 1000 includes a TIMESTAMP data item 610, a TWEET-TEXT data item 630, a SCREEN-NAME data item 640, and an AVATAR-URL data item 650. However, instead of the TWEET-ID data item 620 of result 600, result 1000 includes a RESULT-URL data item 1010 comprising the tweet URL 800. Whereas TWEET-ID data item 620 is a numeric quantity that may not be unique among heterogeneous results, RESULT-URL data item 1010 uniquely identifies among Web pages the page of the Twitter Web site that displays the tweet, making RESULT-URL data item 1010 suitable for use as a result identifier.

Result 1000 further includes a RESULT-TYPE data item 1020 specifying that result 1000 is a tweet result, and data items PAGE-TITLE 1030 and PAGE-SNIPPET 1040 that are left empty because they are not applicable to a tweet result.

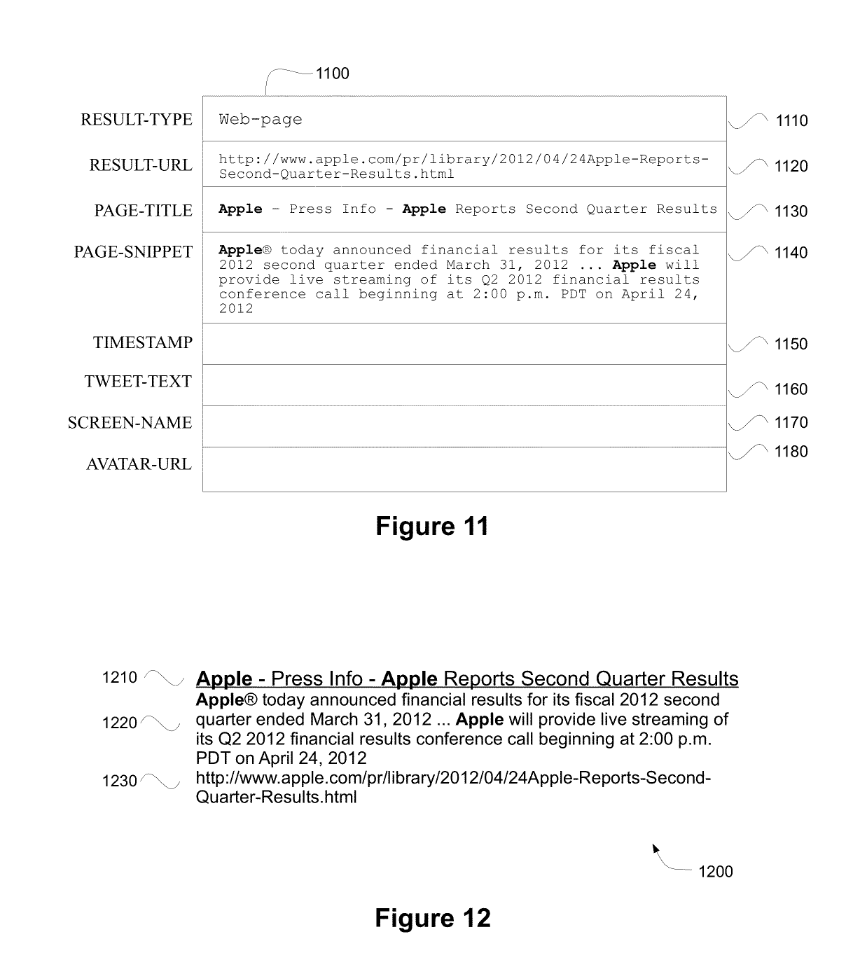

FIG. 11 is a block diagram illustrating an example of a result 1100, according to a heterogeneous embodiment where queries produce results of several different kinds Result 1100 is a record describing a page of the Web site of Apple, Inc. containing a press release. Result 1100 comprises a RESULT-TYPE data item 1110 specifying that result 1100 is a Web-page result describing a Web page, a RESULT-URL data item 1120 providing a URL that points to the page, a PAGE-TITLE data item 1130 comprising the title of the Web page, a PAGE-SNIPPET data item 1140 comprising text extracted from the page, and data items TIMESTAMP 1150, TWEET-TEXT 1160, SCREEN-NAME 1170, and AVATAR-URL 1180 that are not used for a Web-page result in the embodiment. (In an alternative embodiment, TIMESTAMP data item 1150 is used for Web-page results as well as for tweet results, denoting, in the case of a Web-page result, the time of last modification of the corresponding Web page.) RESULT-URL data item 1120 serves as result identifier for result 1100.

FIG. 12 illustrates a rendering 1200 of result 1100 on a display, such as display 210 or touch-screen display 310, according to one embodiment. The rendering comprises: a hyperlink 1210 with PAGE-TITLE data item 1130 as label and RESULT-URL data item 1120 as underlying URL, pointing to the page of the Apple Web site containing the press release; a paragraph 1220 containing PAGE-SNIPPET data item 1140; and a line 1230, with wrap-around as needed, containing RESULT-URL data item 1120. In one embodiment different colors are used to distinguish different elements of the rendering.

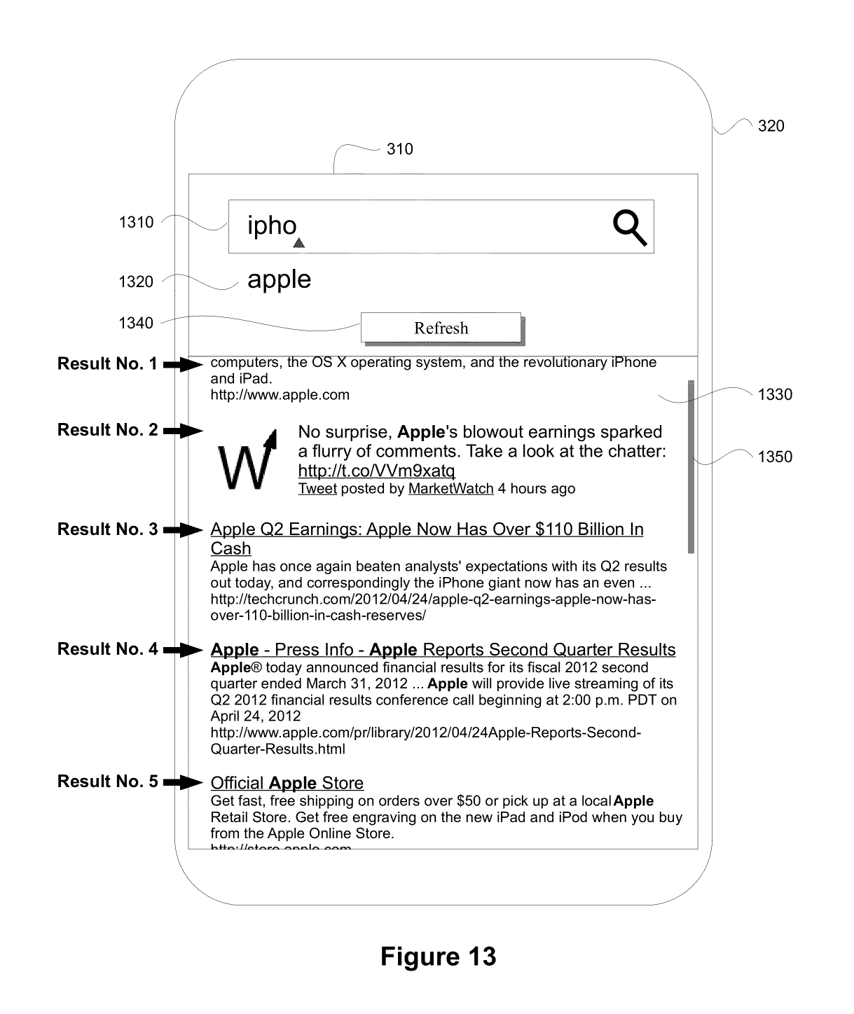

FIG. 13 illustrates an example of user-interface elements shown on touch-screen display 310 of mobile computing device 320, after the user has submitted the query “apple”, according to one embodiment. In the example, in response to the user submitting the query, search application 120 has obtained results Nos. 1-10 of a snapshot of the result set of the query. User-interface elements shown on the display include: a query box 1310 where the user previously entered the query “apple” and has now entered the beginning of a subsequent query, “ipho”; a query line 1320 where the search application has written the query “apple” submitted by the user, whose result set is being browsed; a visual container 1330 that can be scrolled vertically, containing a list of results, viz. results Nos. 1-10; and a refresh button 1340, which is a user-interface element for refreshing the contents of container 1330. It should be noted that the query “ipho” being entered in the query box has not been submitted yet and has no relation to the list of results in container 1330.

In the example, the user has scrolled container 1330 to a position where result No. 1 is partially shown, results Nos. 2-4 are fully visible, result No. 5 is partially visible, and results 6-10 are not visible. In one embodiment, a scroll bar 1350 is visible while scrolling is in progress; in an alternative embodiment, the scroll bar is always visible; in either embodiment, the scroll bar provides a visual indication of the relative size and position of the visible portion of the container with respect to the entirety of the container.

(Scrolling a visual container that can be scrolled vertically means changing its “scrolling position”, defined as the vertical distance in pixels from the top of the container to the top of the visible portion of the container. The scrolling position of the container is 0 when the top of the visual portion of the container coincides with the top of the container. The container is in a “maximally scrolled position” when the bottom of the visible portion of the container coincides with the bottom of the container.)

(Henceforth all distances should be understood to be vertical distances measured in pixels.)

FIG. 14 illustrates an example of user-interface elements shown on touch-screen display 310 of mobile computing device 320, according to an alternative embodiment where there is a visual container 1410 that can be scrolled vertically and whose visible portion occupies the entire area of display 310. In the example, as in the example of FIG. 13, the user has submitted the query “apple” and search application 120 has obtained results Nos. 1-10 of a snapshot of the result set of the query.

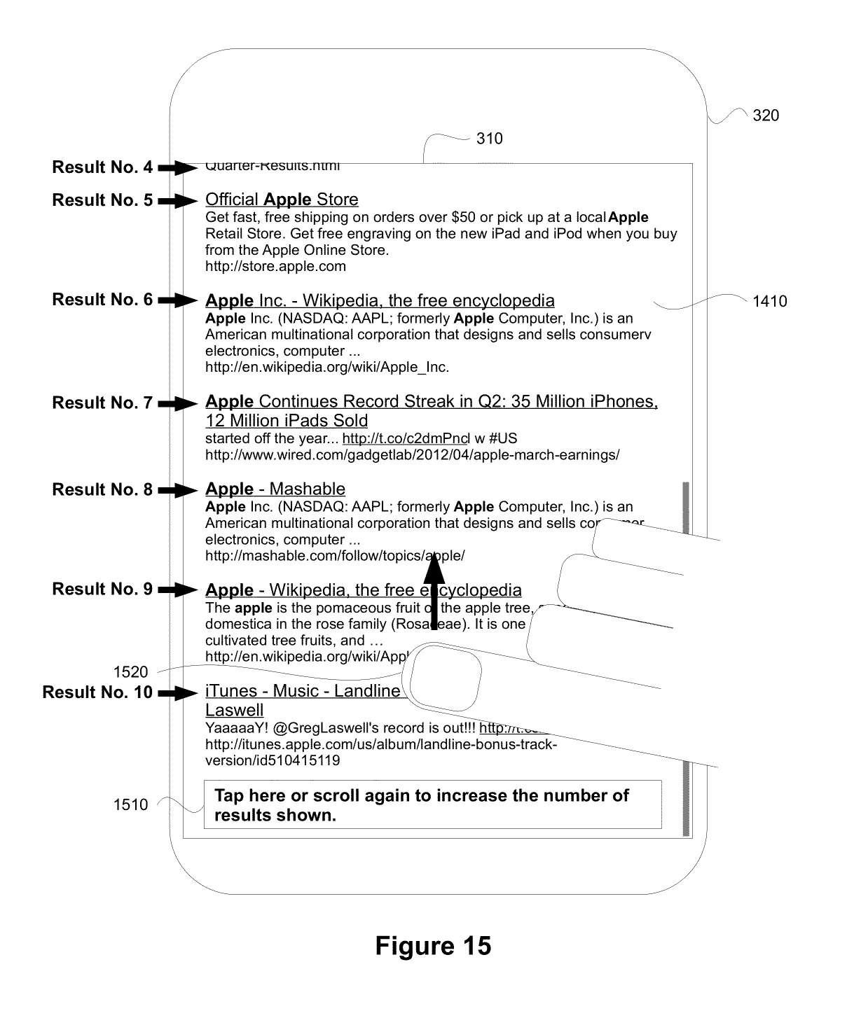

The contents of container 1410 are arranged as a vertical list of visual elements, comprising: a query box 1420, partially visible, where the user previously entered the query “apple” and has now entered the beginning of a subsequent query “ipho”; followed by a query line 1430 where the search application has written the query “apple” submitted by the user, whose result set is being browsed; followed by a refresh button 1440, which is a user-interface element for refreshing the contents of container 1410; followed by a header 1450, which states what results are displayed (results No. 1-10 in the example) and how many results there are (854,000,000 in the example); followed by a list of results, viz. results Nos. 1-10; and optionally followed by a message instructing the user on how to increase the number of results shown in the container. (The message, not visible in the example, is described below in connection with FIG. 15). As in FIG. 13, it should be noted that the query “ipho” being entered in the query box has not been submitted yet and has no relation to the list of results shown below the refresh button.

In the example, the user has scrolled container 1410 to a position where query box 1420 is partially visible, query line 1430, refresh button 1440, header 1450 and results Nos. 1-4 are fully visible, result No. 5 is partially visible, and results Nos. 6-10 are not visible.

FIG. 15 illustrates the touch-screen display 310 of FIG. 14 after the user has scrolled container 1410 to a maximally scrolled position. Query box 1420, query line 1430, refresh button 1440, header 1450 and results Nos. 1-3 are not visible because they have scrolled out of sight; result No. 4 is partially visible, and results Nos. 5-10 are fully visible. The result set snapshot to which results Nos. 1-10 belong has more than 10 results in the example, which causes the results in container 1410 to be followed by a message area 1510 containing a message instructing the user to tap the message area or scroll again in order to increase the number of results shown in the container, i.e. in order to refresh the range of results being displayed and show more results. In one embodiment the text displayed in message area 1510 is “tap here or scroll again to increase the number of results shown”, as illustrated in the figure. In another embodiment the text is “tap here or scroll again to refresh and show more results”. In another embodiment the text of the message is dependent on a user language preference. In the illustration, the user follows the instruction by touching the container with finger 1520 and sliding finger 1520 upwards in a gesture known as a swipe, thus attempting to scroll beyond the maximally scrolled position. Search application 120 interprets the attempt to scroll past the maximally scrolled position as a request for an increase in the number of results shown in the container.

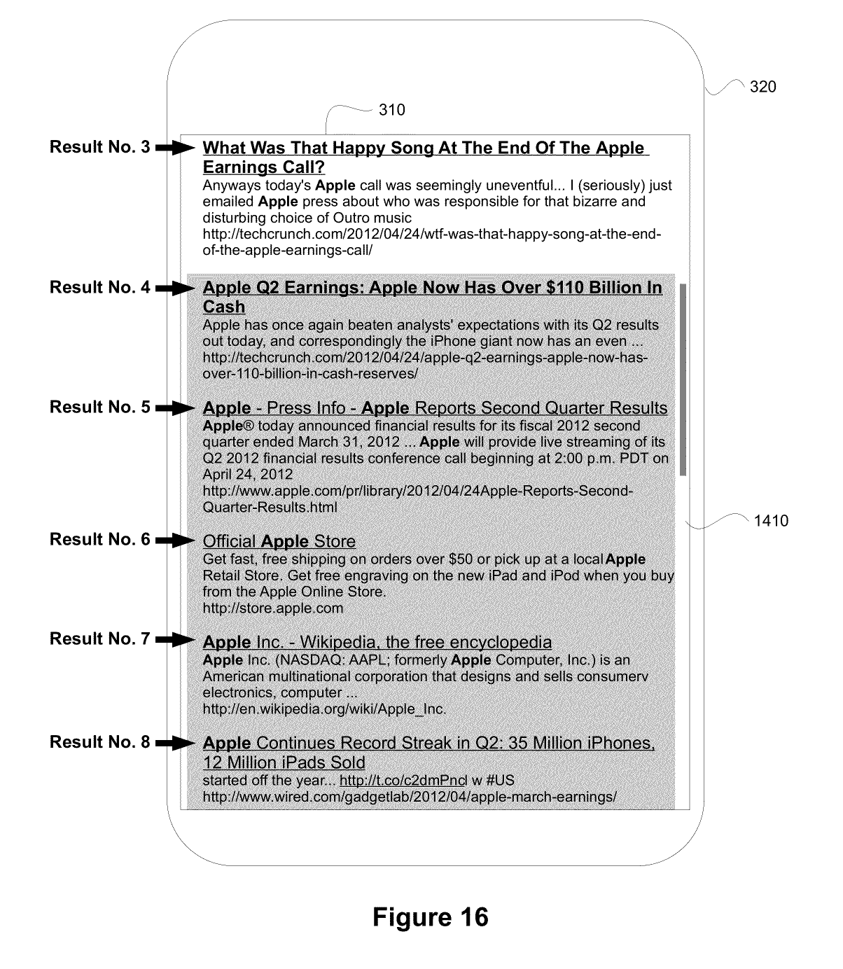

FIG. 16 illustrates the touch-screen display 310 of FIG. 15 after the user has requested an increase in the number of results shown in visual container 1410. Search application 120 has replaced the list of results consisting of results Nos. 1-10 with a list of results consisting of results Nos. 1-20 of a more recent snapshot. It has highlighted those results among results Nos. 1-20 that were not present among the previously shown results Nos. 1-10. Results that are not highlighted are said to be de-emphasized; in one embodiment, highlighted results have bright backgrounds while de-emphasized results have dark backgrounds.

In the example, it is assumed that the result that was result No. 11 in the earlier snapshot is result No. 3 in the more recent snapshot, while results Nos. 1-2 have not changed and results Nos. 3-10 in the earlier snapshot have become results Nos. 4-11 in the more recent snapshot. Consequently, results Nos. 3 and 12-20 (of which only result No. 3 is visible) are now highlighted in container 1410 while results Nos. 1-2 and 4-11 (of which only results Nos. 4-8 are fully or partially visible) are de-emphasized. The search application has automatically scrolled the container so that result No. 3 is visible, at the top of the display. Without such automatic scrolling, the user would not see the result if he or she did not think of manually scrolling towards the top of the container to look for highlighted results.

FIG. 17 illustrates an example of browsing data 150 used by search application 120 while browsing the result set of a query, according to an embodiment that uses container 1410.

The example reflects the state of browsing data 150 after the user submits the query “apple”, obtaining results Nos. 1-10 of a first snapshot of the query “apple”, shown in FIGS. 14-15, then enters the beginning of a subsequent query, “ipho”, then attempts to scroll past a maximally scrolled position as in FIG. 15, causing search application 120 to replace results Nos. 1-10 with results Nos. 1-20 of a second, more recent, snapshot of the result set of the query “apple”, some of which are shown in FIG. 16.

Browsing data 150 comprises:

a SUBMITTED-QUERY data item 1710, comprising the last query submitted by the user, shown in query line 1430, “apple” in the example;

a CONTENTS-OF-QUERY-BOX data item 1720, comprising the query being entered by the user in query box 1420, updated each time the user types or deletes a character in the query box, “ipho” in the example;

a SET-OF-IDS-OF-PREVIOUSLY-SHOWN-RESULTS data item 1730, comprising the set of result identifiers that have been previously shown while browsing the result set of the query that is the value of SUBMITTED-QUERY data item 1710, “apple” in the example;

a CURRENT-CARDINALITY data item 1740, comprising an estimate of the cardinality of the result set, 854,000,000 in the example;

a NUMBER-OF-RESULTS-IN-CONTAINER data item 1750, comprising the number of results present in visual container 1410, 20 in the example;

a LIST-OF-RESULTS-IN-CONTAINER data item 1760, comprising the list of results present in visual container 1410;

a SET-OF-IDS-OF-HIGHLIGHTED-RESULTS data item 1770, comprising the set of identifiers of results that are currently highlighted in container 1410; and

a BATCH-SIZE data item 1780, comprising a batch size, which NUMBER-OF-RESULTS-IN-CONTAINER data item 1750 is a multiple of when it is less than CURRENT-CARDINALITY data item 1740, with value 10 in the example.

If the cardinality of the result set is large enough, the number of results shown in container 1410 is a multiple of the batch size, and increases by the batch size when the user requests an increase in the number of results shown in the container. In one embodiment, the batch size is a user preference with a default value, e.g. 10, that can be changed by the user using a user-interface facility, such as an input box or a menu, provided by search application 120.

The list of results in LIST-OF-RESULTS-IN-CONTAINER data item 1760 is arranged in ascending order by result number starting with result No. 1, the same order in which the results appear in the container. In the example, the list contains results Nos. 1-20 of the second result set snapshot. In the example, each result in the list is depicted as a record containing eight fields, as in FIGS. 10 and 11. The tweet result 1000 of FIG. 10 is result No. 2, and the Web-page result 1100 of FIG. 11 is result No. 5.

SET-OF-IDS-OF-PREVIOUSLY-SHOWN-RESULTS data item 1730 is depicted in FIG. 17 as an array of result identifiers where the identifiers appear in the order in which they are added to the set. The second identifier in the array is the identifier of result No. 2 of the first result set snapshot, i.e. RESULT-URL data item 1010 of the tweet result 1000 of FIG. 10. The fourth identifier in the array is the identifier of result No. 4 of the first result set snapshot, i.e. RESULT-URL data item 1120 of the Web-page result 1100 of FIG. 11. In an alternative embodiment, SET-OF-IDS-OF-PREVIOUSLY-SHOWN-RESULTS data item 1730 is implemented as a hash table.

Similarly, SET-OF-IDS-OF-HIGHLIGHTED-RESULTS data item 1770 is depicted in FIG. 17 as an array of result identifiers. In the example it comprises 10 identifiers, viz. results Nos. 3 and 12-20 of the second snapshot, which were not among results Nos. 1-10 of the first snapshot. In an alternative embodiment, SET-OF-IDS-OF-HIGHLIGHTED-RESULTS data item 1770 is implemented as a hash table.

FIG. 18 is a flow diagram illustrating one embodiment of a process 1800 followed by search application 120 to render an initial list of results in container 1410, in response to the user submitting a query.

At 1810 search application 120 copies the value of CONTENTS-OF-QUERY-BOX data item 1720 to SUBMITTED-QUERY data item 1710. (In an alternative embodiment, search application 120 normalizes the value of CONTENTS-OF-QUERY-BOX data item 120 before copying it to SUBMITTED-QUERY data item 1710. Normalization consists of removing unnecessary white space, removing characters such as punctuation characters that are ignored by back-end 110, and converting to upper-case those Unicode characters that have corresponding upper-case characters. Normalization provides useful information to the user regarding how the back-end processes the query.) Then the search application proceeds to 1820.

At 1820 search application 120 initializes SET-OF-IDS-OF-PREVIOUSLY-SHOWN-RESULTS data item 1730 to the empty set. Then it proceeds to 1830.

At 1830 search application 120 initializes LIST-OF-RESULTS-IN-CONTAINER data item 1760 to the empty list. Then it proceeds to 1840.

At 1840 search application 120 removes all elements that follow query box 1420 in the vertical list of visual elements of container 1410. Then it proceeds to 1850.

At 1850 search application 120 appends query line 1430 to the vertical list of visual elements of container 1410, the text of the query line being the value of SUBMITTED-QUERY data item 1710. Then it proceeds to 1860.

At 1860 search application 120 appends refresh button 1440 to the vertical list of visual elements in container 1410. Then it proceeds to 1870.

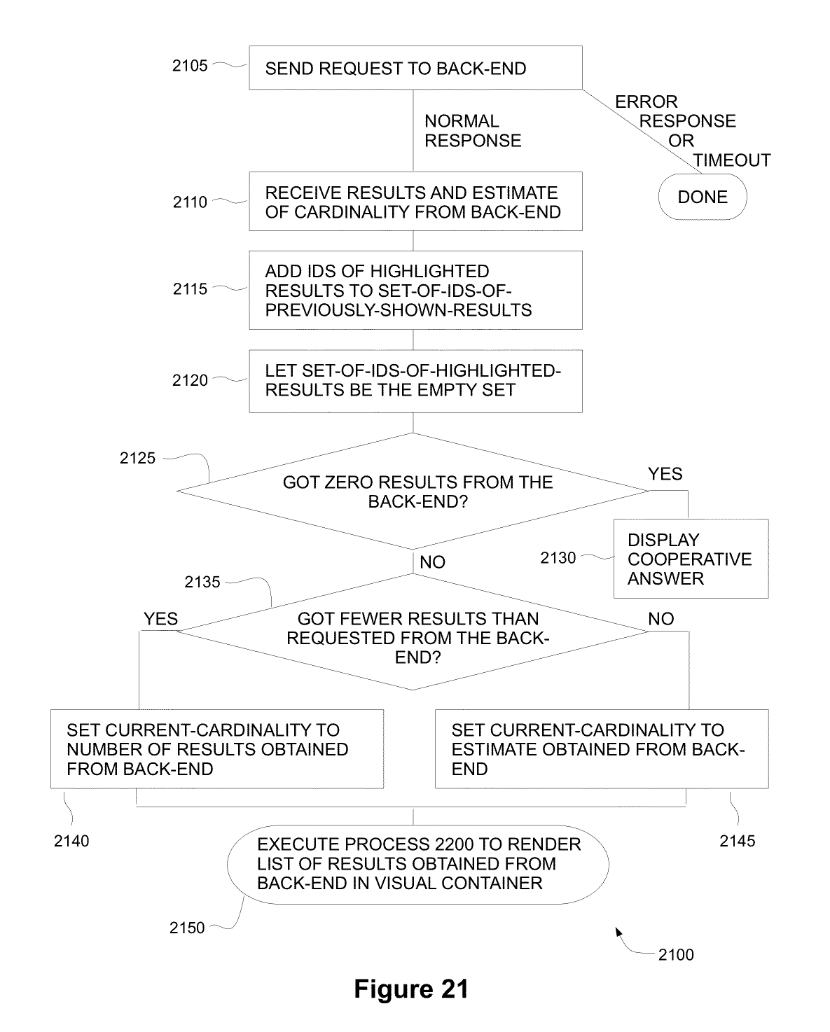

At 1870 search application 120 executes process 2100, described below in connection with FIG. 21, to request results from back-end 110, the number of results requested being the value of BATCH-SIZE data item 1780. If process 2100 is able to obtain results, it appends them to the vertical list of visual elements in container 1410, de-emphasizing any results whose identifiers are found in the set of identifiers of results shown the user, which is the value of SET-OF-IDS-OF-PREVIOUSLY-SHOWN-RESULTS data item 1730. Since SET-OF-IDS-OF-PREVIOUSLY-SHOWN-RESULTS data item 1730 is set to the empty set at step 1820, process 2100 does not de-emphasize any results; all results appended by process 2100 to the vertical list of visual elements in container 1410 are highlighted. After executing process 2100, search application 120 proceeds to 1880.

At 1880 search application 120 sets the scrolling position of container 1410 to 0.

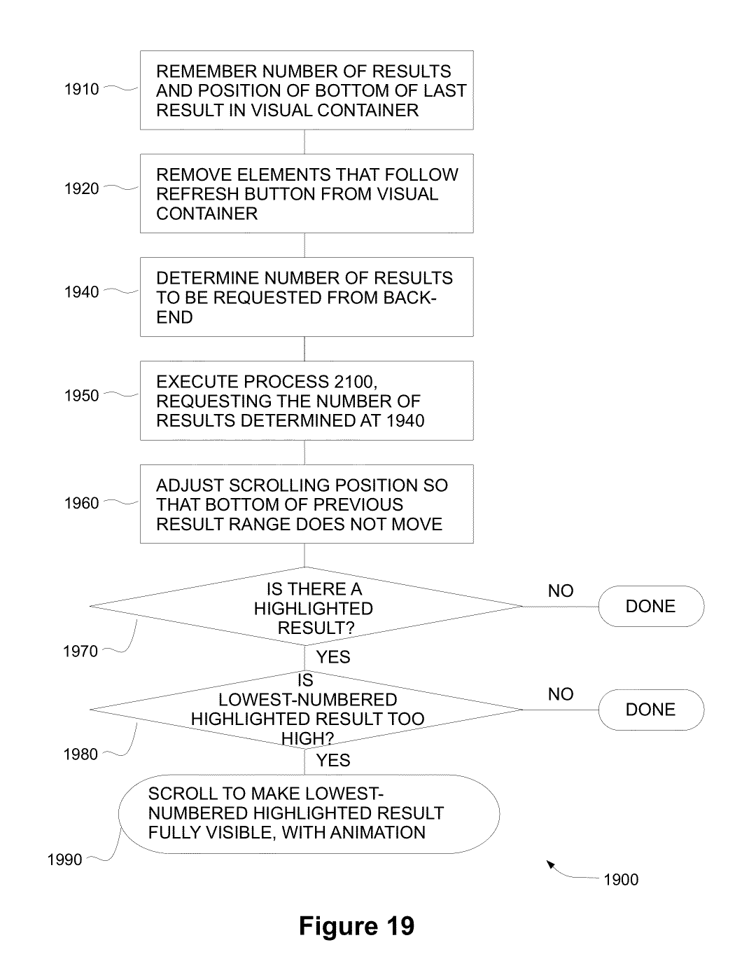

FIG. 19 is a flow diagram illustrating one embodiment of a process 1900 followed by search application 120 upon the user requesting an increase in the number of results shown in container 1410.

At 1910 search application 120 remembers the number of results currently present in container 1410 and the position of the end of the list of results, i.e. the distance from the top of the container to the bottom of the last result in the container. Then it proceeds to 1920.

At 1920 search application 120 removes all visual elements that follow refresh button 1440 in the vertical list of visual elements in container 1410, leaving only query box 1420, query line 1430 and refresh button 1440. Then it proceeds to 1940.

At 1940 search application 120 determines the number of results to be requested from back-end 110.

The number of results to be requested is determined by rounding up the number of results present in container 1410, which is the value of NUMBER-OF-RESULTS-IN-CONTAINER data item 1750, to the nearest nonnegative multiple of the batch size, which is the value of BATCH-SIZE data item 1780, then adding the batch size. For example, if the batch size is 10 and the current number of results is 10 or any positive number less than 10, the number of results to be requested is 20. (As a special case, if the current number of results is 0, the number of results to be requested according to the above computation is 10; however, in one embodiment, if the current number of results is 0, the user is not given any means of requesting an increase in the number of results; the user can use refresh button 1440 to check if results have appeared.)

Then search application 120 proceeds to 1950.

At 1950 search application 120 executes process 2100, described below in connection with FIG. 21, to request from back-end 110 the number of results determined at step 1940. If process 2100 is able to obtain results, it appends them to the vertical list of visual elements in container 1410, highlighting those that have not been previously shown. If there are highlighted results, process 2100 sets a variable in working memory 182 to the position of the lowest-numbered highlighted result, i.e. the distance from the top of container 1410 to the top of the lowest-numbered highlighted result in the container; otherwise it sets the variable to −1. After executing process 2100, the search application proceeds to 1960.

At 1960 search application 120 adjusts the scrolling position of container 1410, if needed and possible, so that the distance from the top of the visible portion of the container to the bottom of the result whose result number is equal to the number of results in the container that was stored in working memory 182 at step 1910, is equal to the distance from the top of the visible portion of the container to the bottom of the last result in the container that was also stored in the working memory at step 1910.

Adjustment is possible unless the number of results in the container is less than it was at step 1910, or the distance from the top of the container to the bottom of the result whose result number is equal to the number of results in the container at step 1910, stored in working memory 182, is less than the distance from the top of the visible portion of the container to the bottom of the last result in the container at step 1910.

If adjustment is needed and possible, it is made by scrolling the container instantaneously, without animation. The effect of the adjustment is that the end of the previous range of results does not move. For example, if the previous range consisted of results Nos. 1-10, the end of the current result No. 10 is at the same position relative to the visible portion of the container as was the end of the previous result No. 10.

If adjustment is needed but not possible, the scrolling position of the container is set to 0.

After step 1960, the search application proceeds to 1970.

At 1970 search application 120 checks if the variable set by process 2100 as discussed above in connection with step 1950 has the value −1. If so, there are no highlighted results and process 1900 terminates. Otherwise there are highlighted results and the search application proceeds to 1980.

At 1980 search application 120 checks if the distance from the top of container 1410 to the top of the lowest-numbered highlighted result in the container, which is the value of the variable set by process 2100 as discussed above in connection with step 1950, is less than the distance from the top of the container to the top of the visual portion of the container. If so it proceeds to 1990. Otherwise process 1900 terminates.

At 1990 search application 120 executes a scrolling animation, gradually moving the visible portion of the container closer to the top of the container by a number of pixels equal to the result of subtracting the value of the variable set by process 2100 as discussed above in connection with step 1950 from the distance between the top of the container and the top of the visual portion of the container. At the end of the animation, the top of the visible portion of the container coincides with the top of the lowest-numbered highlighted result, and thus the lowest-numbered highlighted result is visible.

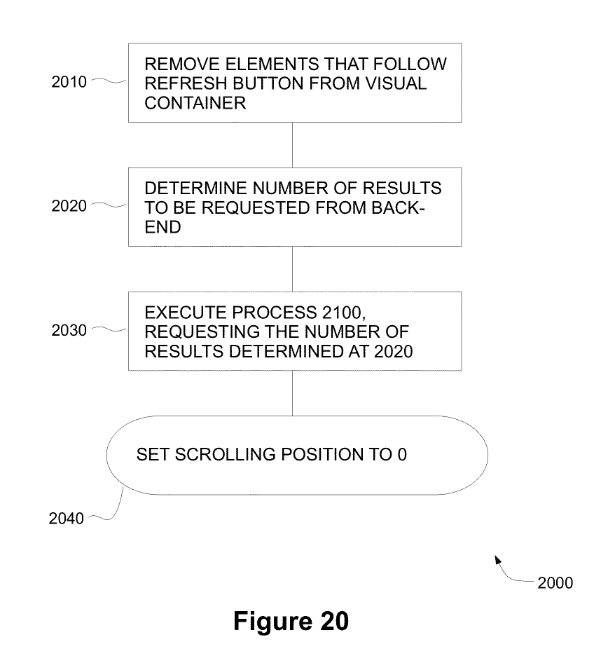

FIG. 20 is a flow diagram illustrating one embodiment of a process 2000 followed by search application 120 in response to the user requesting a refresh of the results in container 1410 by tapping refresh button 1440.

At 2010 search application 120 removes all elements that follow refresh button 1440 in the vertical list of visual elements in container 1410, leaving only query box 1420, query line 1430 and refresh button 1440. Then it proceeds to 2020.

At 2020 search application 120 determines the number of results to be requested from back-end 110, by rounding up the number of results in container 1410, which is the value of NUMBER-OF-RESULTS-IN-CONTAINER data item 1750, to the nearest positive multiple of the batch size, which is the value of BATCH-SIZE data item 1780. (If the current number of results is a multiple of the batch size, the number of results to be requested is equal to the current number of results in the container.) For example, if the batch size is 10 and the current number of results is 10 or less, the number results to be requested is 10. Then search application 120 proceeds to 2030.

At 2030 search application 120 executes process 2100, described below in connection with FIG. 21, to request from back-end 110 the number of results determined at step 2020. If process 2100 is able to obtain results, it appends them to the vertical list of visual elements in container 1410, highlighting those that have not been previously shown. Then search application 120 proceeds to 2040.

At 2040 search application 120 sets the scrolling position of container 1410 to 0.

FIG. 21 is a flow diagram illustrating one embodiment of a process 2100 followed by search application 120 to request a desired number of results of a query from back-end 110 and append the results obtained from the back-end, if any, to the vertical list of visual elements in container 1410, highlighting those that have not been previously shown. The desired number of results is stored in working memory 182 and remains available in the working memory during execution of process 2100.

At 2105 search application 120 sends a request to back-end 110 for a list of consecutive results of a snapshot of the current query starting with result No. 1 and comprising the desired number of results that is stored in the working memory. The current query is the value of SUBMITTED-QUERY data item 1710.

Search application 120 displays an activity indicator such as a rotating wheel while waiting for a response to the request from the back-end. The request may result in an error response or no response, e.g. because the back-end is busy or unreachable. If so process 2100 terminates (after a timeout if no response). If a normal (non-error) response is received the search application proceeds to 2110.

At 2110 search application 120 receives from back-end 110 a list of consecutive results pertaining to a snapshot of the result set of the current query, which it stores as the value of LIST-OF-RESULTS-IN-CONTAINER data item 1760. The list starts with result No. 1 and comprises a number of results less than or equal to the desired number of results that is stored in working memory 182. The search application stores the number of results obtained from the back-end as the value of NUMBER-OF-RESULTS-IN-CONTAINER data item 1750; the number may be zero. The search application also receives from the back-end an estimate of the cardinality of the result set snapshot, which it stores in the working memory. Then it proceeds to 2115.

At 2115 search application 120 adds the result identifiers in SET-OF-IDS-OF-HIGHLIGHTED-RESULTS data item 1770 to SET-OF-IDS-OF-PREVIOUSLY-SHOWN-RESULTS data item 1730. Then it proceeds to 2120.

At 2120 search application 120 sets SET-OF-IDS-OF-HIGHLIGHTED-RESULTS data item 1770 to the empty set. Then it proceeds to 2125.

At 2125 search application 120 checks if the value of NUMBER-OF-RESULTS-IN-CONTAINER data item 1750 is 0, i.e. if the current query produced zero results. If so, the search application proceeds to 2130. Otherwise it proceeds to 2135.

At 2130 search application 120 appends visual elements to the vertical list of visual elements in container 1410, including visual elements informing the user that the current query produced no results and, when possible, visual elements that comprise a cooperative answer to the query, the cooperative answer including suggested follow-up queries as well as more general queries that also fail to produce results. In one embodiment, if the current query is a conjunctive query or a Boolean query, with multiple search terms, the search application uses a method described in U.S. patent application Ser. No. 12/581,859 to compute a cooperative answer through a web API exposed by back-end 110.

At 2135 search application 120 checks if NUMBER-OF-RESULTS-IN-CONTAINER data item 1750, i.e. the number of results obtained from back-end 110, is less than the desired number of results that is stored in working memory 182. If so it proceeds to 2140. Otherwise it proceeds to 2145.

At 2140 search application 120 sets CURRENT-CARDINALITY data item 1740 to the value of NUMBER-OF-RESULTS-IN-CONTAINER data item 1750. Then it proceeds to 2150.

At 2145 search application 120 sets CURRENT-CARDINALITY data item 1740 to the estimate of the cardinality of the result set snapshot provided by back-end 110 and stored in working memory 182 at step 2110. Then it proceeds to 2150.

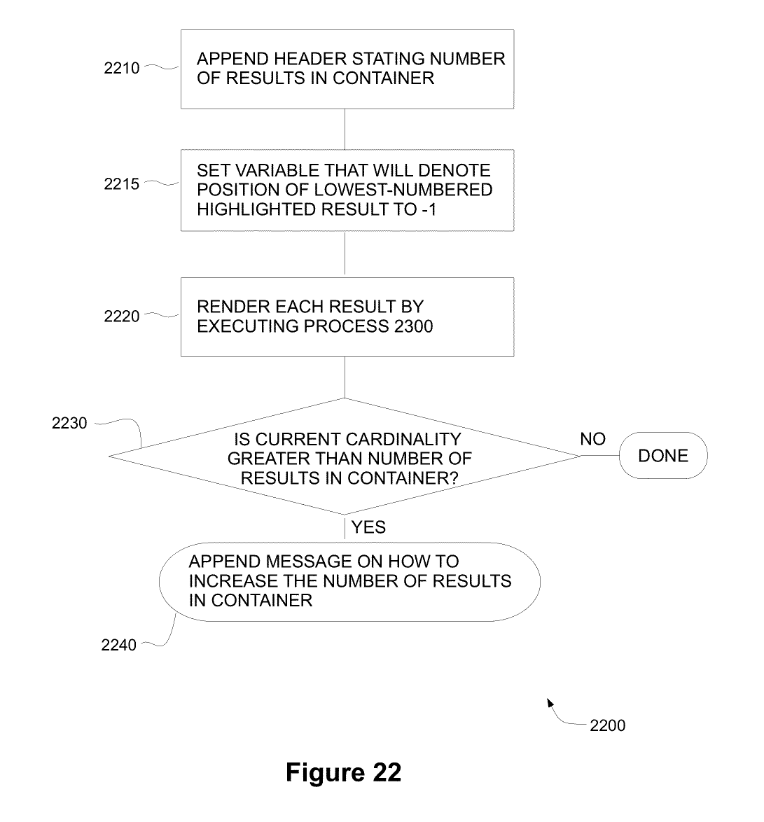

At 2150 search application 120 executes process 2200, described below in connection with FIG. 22, to render the list of results stored as the value of LIST-OF-RESULTS-IN-CONTAINER data item 1760 and append the rendered results to the vertical list of visual elements in container 1410, highlighting those results that have not been previously shown. As each result not previously shown is highlighted, process 2200 adds its result identifier to SET-OF-IDS-OF-HIGHLIGHTED-RESULTS 1770, whence it will be added to SET-OF-IDS-OF-PREVIOUSLY-SHOWN-RESULTS 1730 at step 2115 of a subsequent execution of process 2100. In an alternative embodiment, as process 2200 highlights a result not previously shown, it adds the identifier of the result both to SET-OF-IDS-OF-HIGHLIGHTED-RESULTS 1770 and to SET-OF-IDS-OF-PREVIOUSLY-SHOWN-RESULTS 1730. In such alternative embodiment, step 2115 is omitted in process 2100.

It should be noted that the above-mentioned alternative embodiment, which omits step 2115, reverses the order of the steps of adding identifiers of highlighted results to SET-OF-IDS-OF-PREVIOUSLY-SHOWN-RESULTS 1730 and obtaining subsequent results from back-end 110. Whereas step 2115 adds identifiers of highlighted results to SET-OF-IDS-OF-PREVIOUSLY-SHOWN-RESULTS 1730 after step 2110 has obtained subsequent results from the back-end, in the alternative embodiment identifiers of highlighted results are added to SET-OF-IDS-OF-PREVIOUSLY-SHOWN-RESULTS 1730 by process 2200 before the user has requested a refresh of the results in container 1410 or an increase in the number of results shown in the container that will cause a subsequent execution of process 2100 to obtain subsequent results from the back-end.

FIG. 22 is a flow diagram illustrating one embodiment of a process 2200 followed by search application 120 to render the results in LIST-OF-RESULTS-IN-CONTAINER data item 1760.

At 2210 search application 120 appends header 1450 to the vertical list of visual elements in container 1410, stating the number of results in the container, which is the value or NUMBER-OF-RESULTS-IN-CONTAINER data item 1750, and providing an estimate of the total number of results, which is the value of CURRENT-CARDINALITY data item 1740. Then it proceeds to 2215.

At 2215 search application 120 initializes to −1 a variable in working memory 182, discussed above in connection with step 1950 of process 1900, whose value will eventually be the position of the lowest-numbered highlighted result, i.e. the distance from the top of container 1410 to the top of the lowest-numbered highlighted result in the container, if there are highlighted results; by convention, the value −1 indicates that no highlighted results have been found yet. Then search application 120 proceeds to 2220.

At 2220 search application 120 executes process 2300 for each result in the list of results that is the value of LIST-OF-RESULTS-IN-CONTAINER data item 1760, rendering the result and appending it to the vertical list of visual elements in container 1410, highlighting it if not previously shown, the results being processed in ascending order of result numbers, as arranged in the list. Then the search application proceeds to 2230.

At 2230 search application 120 checks if CURRENT-CARDINALITY data item 1740 is greater than NUMBER-OF-RESULTS-IN-CONTAINER data item 1750. If so, it proceeds to 2240. Otherwise process 2200 terminates.

At 2240 search application 120 appends message area 1510 to the vertical list of visual elements in container 1410, instructing the user on how to increase the number of results in container 1410.

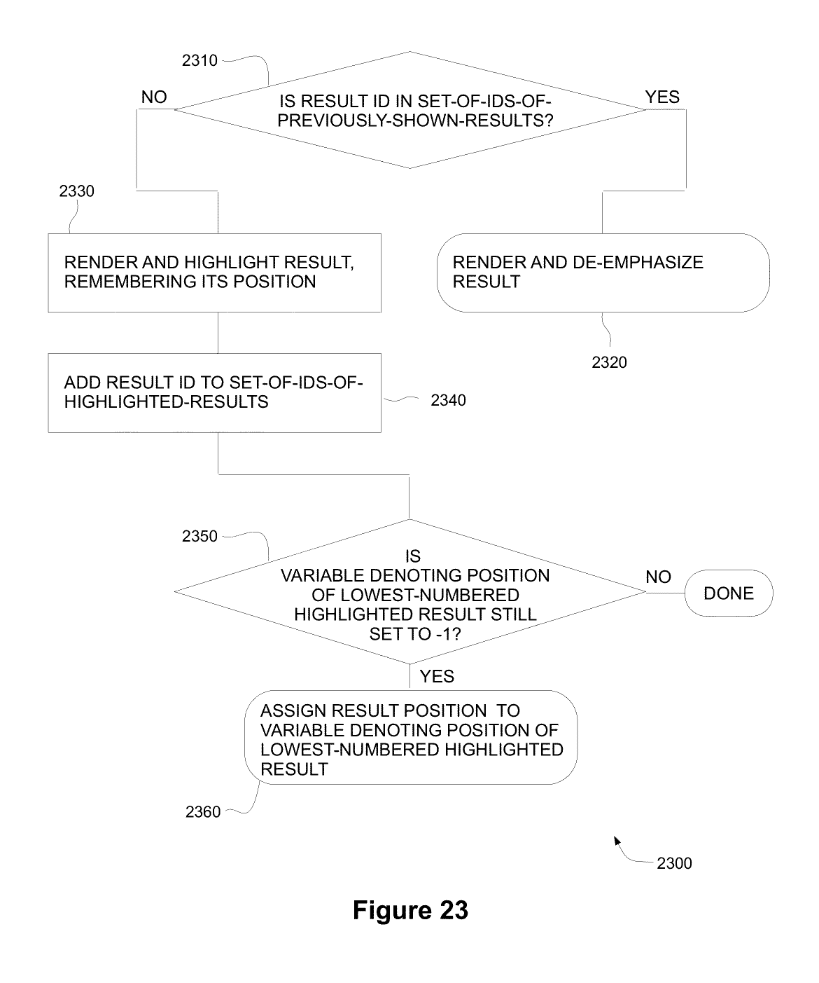

FIG. 23 is a flow diagram illustrating one embodiment of a process 2300 followed by search application 120 to render a result and append it to the vertical list of visual elements in container 1410, highlighting it if not previously shown. The result has a result identifier, such as TWEET-ID data item 620 of FIG. 6 or RESULT-URL data item 1010 of FIG. 10.

At 2310 search application 120 checks if the result identifier is in SET-OF-IDS-OF-PREVIOUSLY-SHOWN-RESULTS data item 1730. If so, it proceeds to 2320. Otherwise it proceeds to 2330.

At 2320 search application 120 renders the result, de-emphasizing it by using a dark background. The result of the rendering is a visual element, which the search application appends to the vertical list of visual elements in container 1410.

At 2330 search application 120 renders the result, highlighting it by using a bright background. The outcome of the rendering is a visual element, which the search application appends to the vertical list of visual elements in container 1410. The search application records in working memory 182 the position of the result within container 1410, i.e. the distance from the top of the container to the top of the appended visual element. Then it proceeds to 2340.

At 2340 search application 120 adds the result identifier to SET-OF-IDS-OF-HIGHLIGHTED-RESULTS data item 1770. In an alternative embodiment discussed above in connection with step 2150 of process 2100, the search application also adds the result identifier to SET-OF-IDS-OF-PREVIOUSLY-SHOWN-RESULTS data item 1730.

Then the search application proceeds to 2350. At 2350 search application 120 checks if the variable initialized at step 2215 of process 2200 still has the value −1, indicating that this is the first non-previously shown result found and will therefore be the lowest numbered highlighted result, since results are processed in ascending order of result numbers at step 2220 of process 2200.

If so the search application proceeds to 2360. Otherwise process 2300 terminates.

At 2360 search application 120 assigns the distance from the top of container 1410 to the top of the appended visual element, stored in working memory 182 at step 2330, to the variable that was initialized at step 2215 of process 2200.

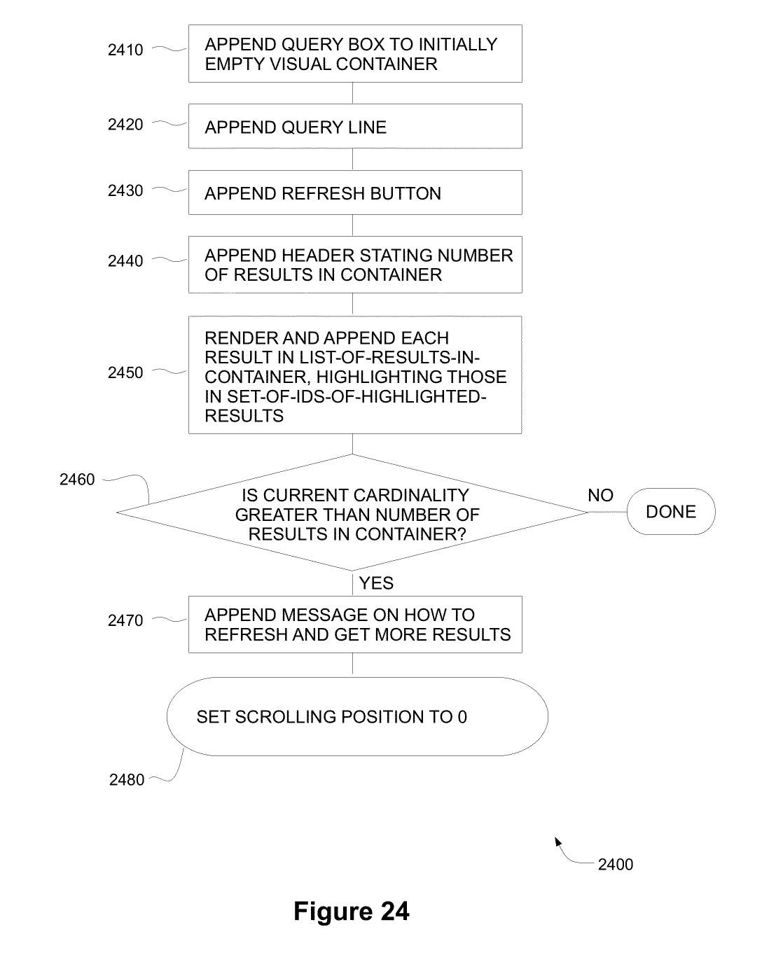

FIG. 24 is a flow diagram illustrating one embodiment of a process 2300 followed by search application 120 to resume the browsing of real-time search results in container 1410 after the search application has exited and restarted, using browsing data 150 that has been preserved in persistent storage.

At 2410 search application 120 appends query box 1420 to the vertical list of visual elements in container 1410, which is initially empty, and enters the value of CONTENTS-OF-QUERY-BOX data item 1720 in the query box 1420. Then it proceeds to 2420.

At 2420 search application 120 appends query line 1430 to the vertical list of visual elements in container 1410, the text of the query line being the value of SUBMITTED-QUERY data item 1710. Then it proceeds to 2430.

At 2430 search application 120 appends the refresh button 1440 to the vertical list of visual elements in container 1410. Then it proceeds to 2440.

At 2440 search application 120 appends header 1450 to the vertical list of visual elements in container 1410, stating the number of results in the container, which is the value or NUMBER-OF-RESULTS-IN-CONTAINER data item 1750, and the total number of results, which is the value of CURRENT-CARDINALITY data item 1740. Then it proceeds to 2450.

At 2450 search application 120 renders each result in LIST-OF-RESULTS-IN-CONTAINER data item 1760, highlighting those whose result identifiers are present in SET-OF-IDS-OF-HIGHLIGHTED-RESULTS data item 1770 and de-emphasizing the rest, appending the rendered results to the vertical list of visual elements in container 1410. Then the search application proceeds to 2460.

At 2460 search application 120 checks if CURRENT-CARDINALITY data item 1740 is greater than NUMBER-OF-RESULTS-IN-CONTAINER data item 1750. If so, it proceeds to 2470. Otherwise process 2400 terminates.

At 2470 search application 120 appends message area 1510 to the vertical list of visual elements in container 1410, instructing the user to tap the message area or scroll again in order to increase the number of results shown in the container. Then it proceeds to 2480.

At 2480 search application 120 sets the scrolling position of container 1410 to 0.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein.

1. A method of updating a first list of results of a search query submitted by a user, the first list being shown in a visual container, the visual container being shown on a display, the method comprising:
obtaining from a search back-end a second list of results of the search query;
adding result identifiers of results of the first list to a set of result identifiers of results that have been previously shown to the user;
rendering the second list in the visual container, the second list replacing the first list; and
highlighting within the second list the results that comprise result identifiers that are not present in the set of result identifiers of results that have been previously shown to the user.

2. The method of claim 1, wherein the result identifiers added to the set of result identifiers of results that have been previously shown to the user are result identifiers of highlighted results.

3. The method of claim 1, wherein the first list is updated in response to a request by the user to refresh the contents of the visual container.

4. The method of claim 1, wherein the first list is updated in response to a request by the user to increase the number of results shown in the visual container.

5. The method of claim 4, wherein the display is a touch-screen display and the user makes the request by tapping a message area.

6. The method of claim 4, wherein the visual container is a scrollable container and the user makes the request by attempting to scroll the container beyond a maximally scrolled position.

7. The method of claim 4, wherein the visual container is a scrollable container and the method further comprises scrolling the container to a scrolling position such that a lowest-numbered highlighted result of the second list is visible.

8. The method of claim 1, wherein at least one result of the search query is a tweet result that describes a tweet.

9. The method of claim 8, wherein the tweet result comprises a tweet identifier that serves as a result identifier.

10. The method of claim 8, wherein the tweet result comprises a tweet URL that serves as a result identifier.

11. The method of claim 1, wherein at least one result of the search query is a Web-page result that describes a Web page, the Web-page result comprising a Web page URL that serves as a result identifier.

12. A system for browsing results of a search query submitted by a user, comprising:
a computing device equipped with a user-interface subsystem that includes a display showing a visual container;
a search back-end;
a network connecting the computing device to the search back-end; and
a search application running on the computing device and programmed to perform a method of updating a first list of results of the search query, the first list being shown in the visual container, the method comprising adding result identifiers of results of the first list to a set of result identifiers of results that have been previously shown to the user, replacing the first list with a second list of results of the search query obtained from the search back-end, and highlighting within the second list the results that comprise result identifiers that are not present in the set of result identifiers of results that have been previously shown to the user.

13. The system of claim 12, further comprising a persistent storage where browsing data is preserved while the search application is not running, the browsing data including the set of result identifiers of results that have been previously shown to the user, the search application being further programmed to resume the browsing of results of the search query after the search application exits and restarts.

14. The system of claim 12, wherein the method of updating the first list of results is performed by the search application in response to a request by the user to increase the number of results shown in the visual container.

15. The system of claim 14, wherein the computing device is a mobile computing device, the display is a touch-screen display and the user makes the request by tapping a message area.

16. The system of claim 14, wherein the computing device is a mobile computing device, the display is a touch-screen display, the visual container is a scrollable container and the user makes the request by touching the container with a finger when the container is in a maximally scrolled position and sliding the finger upwards.

17. The system of claim 14, wherein the visual container is a scrollable container and the method of updating the first list of results performed by the search application further comprises scrolling the visual container to a scrolling position such that a lowest-numbered highlighted result of the second list is visible.

18. The system of claim 12, wherein the search application is embedded in a web page that has been downloaded into a web browser running on the computing device.

19. The system of claim 12, wherein the computing device is a mobile computing device and the search application is a native application running on the mobile computing device.

20. A computer readable storage medium storing computer-executable instructions for controlling a computing device to perform a method of updating a first list of results of a search query submitted by a user, the first list being shown in a visual container, the visual container being shown on a display, the method comprising:
adding result identifiers of results of the first list to a set of result identifiers of results that have been previously shown to the user;
obtaining from a search back-end a second list of results of the search query;
rendering the second list in the visual container, the second list replacing the first list; and
highlighting within the second list the results that comprise result identifiers that are not present in the set of result identifiers of results that have been previously shown to the user.
